(19) United States
(12) Patent Application Publication
(10) Pub. No.: US 2014/0185790 A1
(43) Pub. Date: Jul. 3, 2014

(54) AVERAGE HANDLING TIME REPORTING SYSTEM

(71) Applicant: Florida Power & Light Company, Juno Beach, FL (US)

(72) Inventors: John T. Leta, Coconut Creek, FL (US); Cristina Albacete, Miami, FL (US); George E. Reyes, Miami, FL (US); John W. Maniscalco, Pembroke Pines, FL (US); Andres Martinez, Miami, FL (US)

(73) Assignee: Florida Power & Light Company, Juno Beach, FL (US)

(21) Appl. No.: 14/143,969

(22) Filed: Dec. 30, 2013

Related U.S. Application Data
(60) Provisional application No. 61/747,500, filed on Dec. 31, 2012.

(51) Int. Cl. H04M 3/51

(52) U.S. Cl. CPC H04M 3/5175
USPC 379/265.08

(57) ABSTRACT

Disclosed is a computer-implemented method for providing a view of performance of a plurality of customer service agents across an enterprise. The method includes receiving data corresponding to call handling for the plurality of agents from application programs executing on at least two computers located in different customer service operation sites; processing the received data to generate performance data for the different sites and for different agent skills; and transmitting a display signal with average handle time data.

### CROSS REFERENCE TO RELATED APPLICATIONS

This application claims the benefit of U.S. Provisional Application No. 61/747,500, filed Dec. 31, 2012, the entire contents of which are herein incorporated by reference.

### BACKGROUND OF THE INVENTION

1. Field of the Invention

The invention relates generally to call centers or other call processing systems in which voice calls, e-mails, faxes, voice messages, text messages, Internet service requests and other types of communications are distributed among a number of service agents for handling. More particularly, the invention relates to an Average Handling Time (“AHT”) Tracking Interactive Reporting system that quickly identifies individual agent actions that affect handle time and reports how those actions are contributing to overall AHT (e.g., across multiple call centers).

2. Description of the Related Art

Call centers provide a wide array of services for customers of the companies that use them. Through a call center, a company can service customers around the world, around the clock. The essence of call center effectiveness and efficiency, however, is the performance of the call center service representatives or agents that serve the calling customers. Call center supervisors manage call service representatives and are responsible for monitoring their performance. Call center supervisors may monitor service representatives' calls for various reasons, including: to provide training to the customer service representatives, to assure the quality of customer service, and to maintain security within the company.

For a call center that uses an automatic call distributor (ACD), private branch exchange (PBX), or other suitable routing device, there typically exist features that are integral to the ACD that enable monitoring of service representative performance. These capabilities, however, are generally manual and have significant limitations. With other demands on their time and attention, supervisors may not be consistent or equitable in the ways that they monitor each agent. These inconsistencies and inequities may result in a supervisor monitoring an agent either for too little time or too much time, or too infrequently or too frequently. This may cause an imbalance in the supervisor's perception of an agent relative to other agents in the call center.

Another problem that manual scheduling and monitoring of agents causes is increased time pressure on the supervisors themselves. For example, they must remember who has been monitored, for how long they have monitored or intend to monitor an agent, and when to monitor the agent. If a call center has numerous service representatives, the requirement to monitor the performance of these agents may seriously and adversely affect the productivity of the call center supervisor. This is because the task of monitoring agents is only one of many tasks that the supervisor must perform.

Adding to the problems in the art pointed out above, a single entity may run different call centers across a territory. Thus, there is a need in the art for a system that analyzes and identifies which agent actions during a call affect handle time and identifies the contribution of each agent to overall handle time, including handle time across several call centers. There is a further need in the art for a system that provides specific details that management can use to make decisions of positive corrective training or process improvements.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with one embodiment, the present disclosure describes a computer-implemented method for providing a view of performance of a plurality of customer service agents across an enterprise. The method includes receiving data corresponding to call handling for the plurality of agents from application programs executing on at least two computers located in different customer service operation sites; processing the received data to generate performance data for the different sites and for different agent skills; and transmitting a display signal with average handle time data.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a drill down report showing agent performance metrics based on customer service sites in accordance with one embodiment;

FIG. 2 illustrates a drill down report showing agent performance metrics based on customer service sites in accordance with one embodiment;

FIG. 3 illustrates a drill down report showing agent performance metrics based on agent skills in accordance with one embodiment;

FIG. 4 illustrates a grading report showing agent performance scores in accordance with one embodiment; and

FIG. 5 illustrates a bell curve report for all agents graded in accordance with one embodiment.

### DESCRIPTION OF ILLUSTRATIVE EMBODIMENTS OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

As used herein, an element or step recited in the singular and proceeded with the word “a” or “an” should be understood as not excluding plural of said elements or steps, unless such exclusion is explicitly stated. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense.

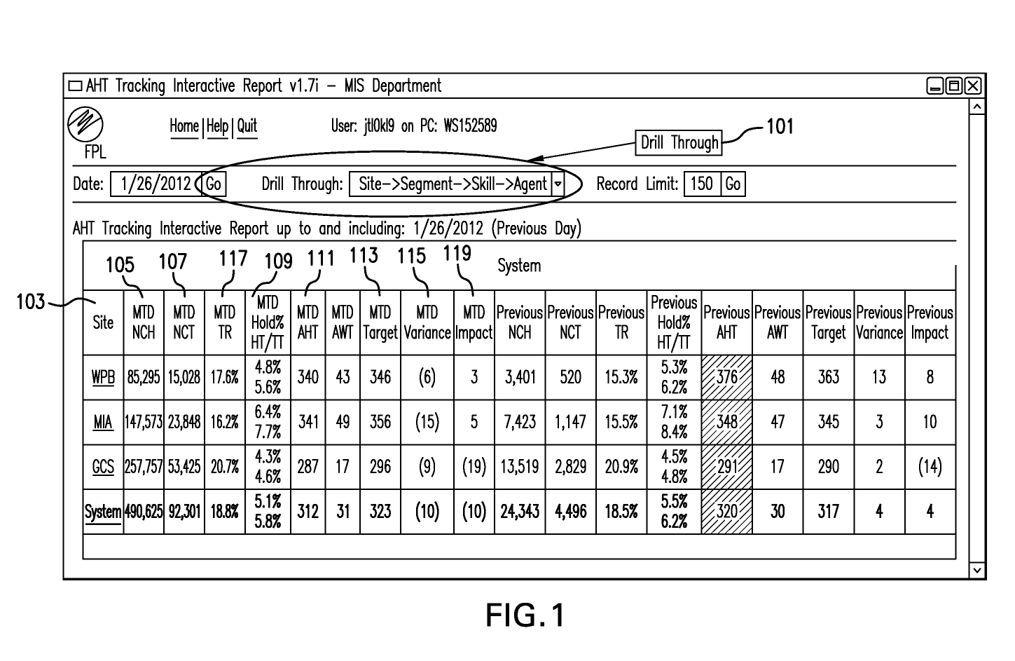

With reference to FIG. 1, the AHT Tracking Interactive Reporting System of the present invention may be implemented as an interactive drill-through software 101 for management to quickly identify individual agent actions that affect handle time and understand how those actions are contributing to overall AHT, including AHT across different call centers 103 run by an enterprise, for example. The enterprise or management may use information generated by the reporting tool to help coach outliers and identify coaching opportunities regarding skill training and AHT components.

In one embodiment, the reporting system displays month to date (MTD) data (e.g., number of calls handled 105, number of calls transferred 107, hold time 109, AHT 111, after call work, AHT target 113, target variance 115, target contribution) compared to the prior day. The report provides the user of the system (e.g., managers) with views of current and prior day MTD AHT performance against targets.

One advantage of the reporting system of the present invention is that it provides the ability to measure agents call handle time by taking into account their call mix. Individual agent, supervisor, segment and site targets may vary on a daily basis depending on the call mix. Call mix may be defined as the percentage of calls for each call type that an Agent may handle on any particular day. These targets may be re-calculated daily based on call mix for both MTD as well as previous day data and they may be used to measure performance against targets. That is, the targets automatically change as the data is rolled up from a skill level (or call type) to segment, site, supervisor, and so on. The targets are fixed based on the year, month, site, segment, and skill (or call type) and therefore, as the call types change, the targets at the rolled up levels change. This is especially beneficial if sites (e.g., call centers at different locations) have slightly different call groups. A call group refers to one site having “Premise Research” call types, for example a site in Miami, Fla., but other sites in other cities not having such call types. If a Call Center has multiple Call Segments within their Career Path (Collections, New Service, Sales and Service, etc.), the employees' performance may be measured and compared to that of employees in the same segment or having a same training or skill. Call segments may be defined as groups of skills (or call types) for reporting.

In one embodiment, the AHT system of the present invention identifies agents meeting overall performance and identifies agents having individual areas within their skills that are not meeting targets on all levels as the data is rolled up. As a result, users of the system of the present invention can more easily provide specific coaching to all employees.

Various outlier reports for management can be subscribed to that identify outliers and are delivered via text message and/or email automatically periodically (e.g., hourly, daily, weekly, monthly, etc.). An outlier may be defined as an agent that is underperforming in a given area. An outlier may also be defined as any other rolled up level (e.g. skill, segment, site, and supervisor) that is underperforming.

In one embodiment, the system of the present invention may use color coding to identify AHT missed targets for MTD as well a previous day data. This feature may be implemented at the system level down to the individual agent. For example, the various levels may include System, Site, Segment, Skill, Operations Supervisor, Supervisor, and Agent. This feature further allows management to quickly identify and follow AHT gaps from a macro view, at system level, and all the way to a micro level view at individual agent level, utilizing a drill-through format (101).

The system of the present invention may also include a drill-through format and color coding to identify agents that have consistently or historically missed their targets (e.g., by skill) over a three-month period, for example. This feature allows supervisors to easily identify outliers in their group (i.e., group of agents assigned to a supervisor). It also allows the supervisors to understand which call types (skills) the representative has difficulty with in order to effectively coach the employee. In one embodiment, at the agent level, data is provided in detail for the last 30 days and prior months to facilitate trending analysis.

In addition to the ability of identifying outlier agents through the drill through menus, the present invention may provide a special menu designed to view outliers only. For example, a “Missed Prior (3) Months AHT Targets” option in the reporting system allows system users to view the number of outlier agents, percentage of outlier agents, percentage of skills that have been missed by the agent in the past 3 months, percentage of calls handled outside the AHT target, and total calls handled outside the AHT target. By using this menu, a supervisor can gain an understanding of the magnitude of the outlier population and focus efforts to assist the agents meet the desired target(s).

In one embodiment, the system of the present invention may also provide a grading method that measures the impact an agent has on AHT from the system level to the supervisor level using a scale from 0 to 5. The grading report may be based on rating the employee or agent individual performance against the entire population (e.g., across different call centers) in a normal distribution. Grades may be assigned by identifying the distance from the mean or standard deviation. As agents move away from the mean approaching+3 sigma the score will get closer to 5 (high negative impact). In addition, the reporting system may track the employee behavior that could be causing higher than desired AHT, for example hold time, average work time, etc. In one embodiment, the system may generate coaching statements with respect to specific areas where the agent is contributing most to AHT.

FIG. 1 illustrates one system level view of a report generated by the system of the present invention in accordance with one embodiment.

NCH 105 may be defined as the Number of calls handled; NCT 107 may be defined as the Number of calls Transferred; TR 117 may be defined as the Transfer Rate (NCT/NCH); Hold % (HT) 109 may be defined as the percentage of hold time as it relates to Handle Time; Hold % (TT) 109 may be defined as the percentage of hold time as it relates to Talk Time; MTD Target 113 may be defined as the AHT rolled up to the current month; MTD Variance 115 may be defined as the variance from MTD Actual AHT to Target AHT; and MTD Impact 119 may be defined as the number of seconds of AHT that contributed to the total MTD Variance.

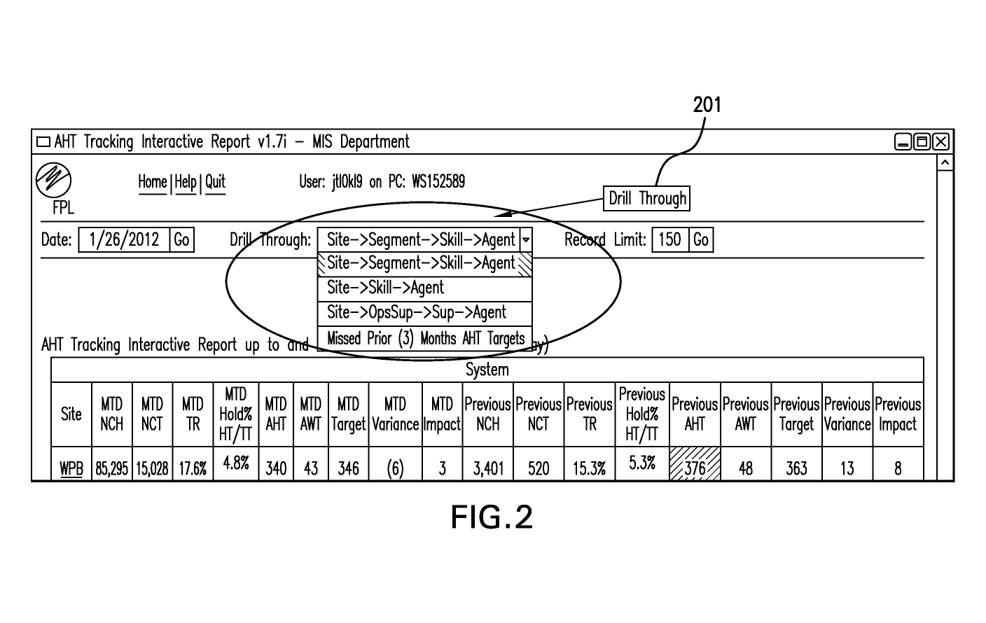

FIG. 2 illustrates one site level view of a dill-through selection 201 enabled by the system of the present invention in accordance with one embodiment.

With reference to the figure, a segment may be defined as a group of skills or Call types for reporting; a Skill may be defined as a Call Type; OpsSup refers to the Operations Supervisor; and Sup refers to the Supervisor.

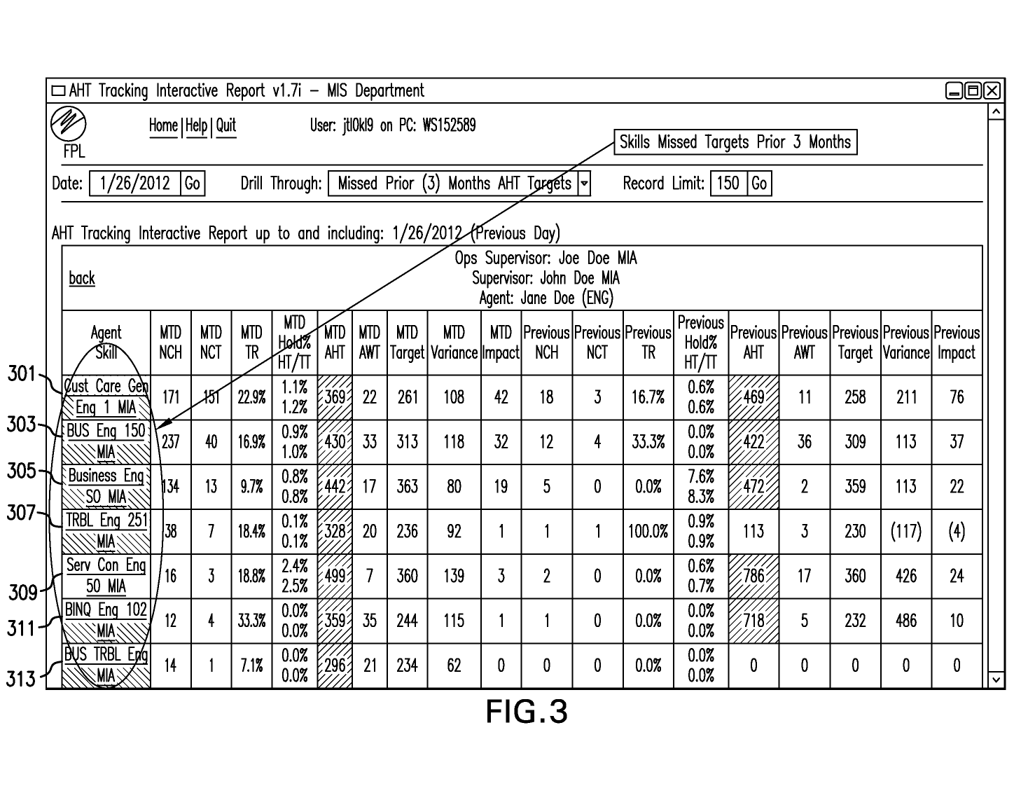

FIG. 3 illustrates one agent view of a report generated by the system of the present invention in accordance with one embodiment. The report highlights the skills for which the AHT targets have been missed during a 3-month period 301.

Skill descriptions may be defined as follows: “Cust Care Gen Eng 1 MIA” 301 is Customer Care Generalist English (skill number 1) from a site identified as “MIA”; “BUS Eng 150 MIA” 303 is Business English (Skill Number 150) from the MIA site; “Business Eng SO MIA” 305 is Business English Service Orders from the MIA site; “TRBL Eng 251 MIA” 307 is Trouble English (skill 251) from the MIA site; “Serv Con Eng 50 MIA” 309 is Service Connects English (skill 50) from MIA site; “BINQ Eng 102 MIA” 311 is Billing Inquiry English (skill 102) from the MIA site; and “Bus Trbl Eng 254 MIA”—313 is Business Trouble English (skill 254) from the MIA site. The Service Connects 309—is not highlighted because the Agent has not missed the AHT targets for the prior 3 months.

The skill number may represent a particular call type. In one embodiment, calls are routed based on skills and agents receive calls from skills that they are assigned. This allows an agent with specific training for a call type to receive calls of that type. Agents can be assigned many skills based on their individual training. In one embodiment, call types, on the other hand, only route to one skill.

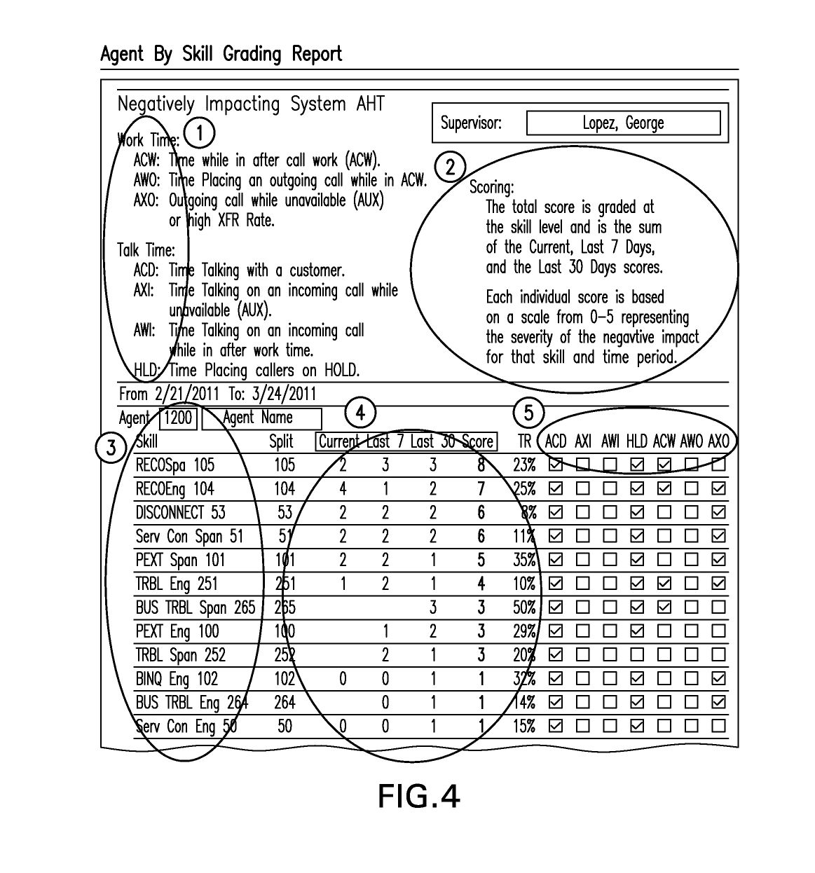

FIG. 4 illustrates an agent grading report generated by the system of the present invention in accordance with one embodiment. In FIG. 4, the groups of acronyms denoted with numeral “1” represent agent actions that result in impacting the AHT. The Work Time related actions or metrics include: a) ACW: Time While in after call work; b) AWO: Time Placing an outgoing call while in ACW; and c) AXO: Outgoing call while the agent is unavailable (AUX) or high Transfer (XFR) Rate. The Talk Time related actions or metrics include: a) ACD: Time Talking with a customer; b) AXI: Time Talking on an incoming call while unavailable (AUX); c) AWI: Time Talking on an incoming call while in after work time (the time accumulated when an Agent is in ACW and receives an incoming call); and d) HLD: Time Placing callers on HOLD.

After call work may be defined as the time the agent continues to work that is related to the call and starts accumulating after the call has ended. This time is associated to the call's skill.

The section denoted with numeral “2” provides an informational notice to the user with respect to score interpretation. The total score may be graded at the skill level and is the sum of the current, Last 7 Days and Last 30 Days scores in the illustrated embodiment (see numeral “4”). Each individual score may be based on a scale from 0-5 representing the severity of the negative impact for that skill and time period. The scoring is broken down into three categories to get a feel for how the Agent has been impacting AHT yesterday, last week and the last 30 days.

FIG. 4 also illustrates a list of agent skills “3.” Each skill the Agent has taken calls on, where the overall AHT for that skill has been negatively impacted by those calls, may be listed on the report. The section “5” in the report shows that an agent action is checked off if those actions were the main contributor to the Agent's negative impact seconds for that skill. Negative Impact Seconds may be defined as the number of seconds that the agent's performance impacts their overall Average Handle Time (e.g., too much ACW will negatively impact the Agent's overall AHT).

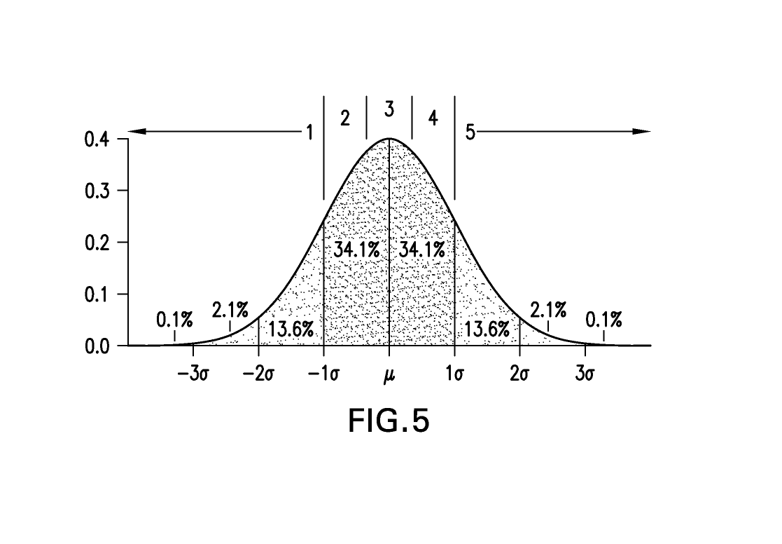

FIG. 5 illustrates a bell curve report for all agents graded which is generated by the system of the present invention in accordance with one embodiment. Based on the overall agent's statistics, an agent is given a score of zero (“0”) for a particular skill when the Agent's negative impact seconds for that skill are zero (“0”); a score of one (“1”) when the negative impact seconds are less than −1 standard deviation; a score of two (“2”) when the negative impact seconds are in the bottom ⅓ of −1 standard deviation to +1 standard deviation; a score of three (“3”) when the negative impact seconds are in the middle of ⅓ of −1 standard deviation to +1 standard deviation; a score of four (“4”) when the negative impact seconds are in the top ⅓ of −1 standard deviation to +1 standard deviation; and a score of five (“5”) when the negative impact seconds are greater than +1 standard deviation. A person of ordinary skill in the art would recognize that other scoring methods may be used based on different criteria applied to a bell curve or other statistical curve.

The AHT report system of the present invention may be used daily by management to understand agent actions that affect AHT and make positive corrections to reduce overall AHT. The system of the present invention may include additional metrics beyond Handle Time, Transfer Rates and AHT Targets. For example, the system of the present invention may include additional quality, performance, and budgetary metrics.

The benefits to lowering AHT are significant. AHT reductions are directly related to workload, in some cases, a 1.5 second system AHT reduction equates to 1 FTE (Full Time Employee). This relationship will vary by call center based on workload (AHT*Call volume).

With regular use of the system of the present invention, management can pin-point the agents that have the highest contribution to AHT variance from target/budget and understand the actions of the agent and offer corrective training or process improvements.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer.”

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description.

The foregoing description of possible implementations consistent with the present invention does not represent a comprehensive list of all such implementations or all variations of the implementations described. The description of only some implementation should not be construed as an intent to exclude other implementations. For example, artisans will understand how to implement the invention in many other ways, using equivalents and alternatives that do not depart from the scope of the invention. Moreover, unless indicated to the contrary in the preceding description, none of the components described in the implementations are essential to the invention.

1. A computer-implemented method for providing a view of performance of a plurality of customer service agents across an enterprise, the method comprising:
receiving data corresponding to call handling for said plurality of agents from application programs executing on at least two computers located in different customer service operation sites;
processing said data to generate performance data for the different sites and for different agent skills; and
transmitting a display signal with average handle time data.

2. The method of claim 1, wherein the average handle time data corresponds to a first agent and is displayed for at least two different agent skills.

3. The method of claim 1, wherein the average handle time data is computed on a per site basis and is displayed for at least two different sites.

4. The method of claim 2, further comprising transmitting at least one of the following as part of the display signal:
number of calls handled per agent skill;
number of calls transferred per agent skill;
transfer rate per agent skill;
percentage of hold time as it relates to handle time per agent skill;
percentage of hold time as it relates to talk time per agent skill;
month to date target per agent skill;
month to date variance per agent skill; or
month to date impact per agent skill.

5. The method of claim 3, further comprising transmitting at least one of the following as part of the display signal:
number of calls handled per site;
number of calls transferred per site;
transfer rate per site;
percentage of hold time as it relates to handle time per site;
percentage of hold time as it relates to talk time per site;
month to date target per site;
month to date variance per site; or
month to date impact per site.

6. The method of claim 1, further comprising transmitting agent score data as part of the display signal.

7. The method of claim 6, further comprising calculating said score data based on a statistical agent skill curve.

8. The method of claim 1, further comprising transmitting data indicative of actions that contribute to agents' negative impact seconds.

9. A computer-readable storage medium containing a data server application, which when executed on a processor is configured to perform an operation providing a view of performance of a plurality of customer service agents across an enterprise, the operation comprising:
receiving data corresponding to call handling for said plurality of agents from application programs executing on at least two computers located in different customer service operation sites;
processing said data to generate performance data for the different sites and for different agent skills; and
transmitting a display signal with average handle time data.

10. The computer-readable storage medium of claim 9, wherein the average handle time data corresponds to a first agent and is displayed for at least two different agent skills.

11. The computer-readable storage medium of claim 9, wherein the average handle time data is computed on a per site basis and is displayed for at least two different sites.

12. The computer-readable storage medium of claim 10, further comprising transmitting at least one of the following as part of the display signal:
number of calls handled per agent skill;
number of calls transferred per agent skill;
transfer rate per agent skill;
percentage of hold time as it relates to handle time per agent skill;
percentage of hold time as it relates to talk time per agent skill;
month to date target per agent skill;
month to date variance per agent skill; or
month to date impact per agent skill.

13. The computer-readable storage medium of claim 11, further comprising transmitting at least one of the following as part of the display signal:
number of calls handled per site;
number of calls transferred per site;
transfer rate per site;
percentage of hold time as it relates to handle time per site;
percentage of hold time as it relates to talk time per site;
month to date target per site;
month to date variance per site; or
month to date impact per site.

14. The computer-readable storage medium of claim 9, further comprising transmitting agent score data as part of the display signal.

15. The computer-readable storage medium of claim 14, further comprising calculating said score data based on a statistical agent skill curve.

16. The computer-readable storage medium of claim 9, further comprising transmitting data indicative of actions that contribute to agents' negative impact seconds.
